(19) United States
(12) Patent Application Publication
(10) Pub. No.: US 2026/0189415 A1
(43) Pub. Date: Jul. 2, 2026

(54) POLARITY SWITCHING MODULE FOR HYBRID FIBER COAXIAL NETWORKS

(71) Applicant: TECHNETIX B.V., Veenendaal (NL)

(72) Inventors: Diego ROYO MOROS, Veenendaal (NL); Jan ARIESEN, Veenendaal (NL)

(21) Appl. No.: 19/131,188

(22) PCT Filed: Sep. 5, 2023
(86) PCT No.: PCT/EP2023/074274

§ 371 Date: May 19, 2025

(30) Foreign Application Priority Data
Jan. 27, 2023 (GB) 2301177.8

(51) Int. Cl. H04L 12/10; H02J 1/00; H04L 12/28

(52) U.S. Cl. CPC H04L 12/10; H02J 1/00; H04L 12/2801

(57) ABSTRACT

There is provided a hybrid fiber coaxial network polarity switching module (60) connectable to a DC power signal obtained by rectification of an AC power signal and comprising a controller (64) in electrical communication with an H-bridge circuit (62), wherein the controller (64) is configured to act on the H-bridge circuit (62) to switch polarity of the DC power signal during a transition time less than or equal to the effective time of the AC power signal. A method of switching polarity in an HFC network is also provided.

### FIELD OF THE INVENTION

This invention relates to a polarity switching module for changing the polarity of DC power signals within hybrid fiber coaxial networks.

### BACKGROUND TO THE INVENTION

In a hybrid fiber coaxial (HFC) network, the AC mains power signal is transformed to a lower voltage AC power signal with different waveforms like sinusoid or trapezium and used to power active elements within the network, such as amplifiers and nodes.

The AC power signal has an influence on the power supplies of the active elements with the active elements requiring a large current peak when the AC voltage is greater than the effective voltage V_{eff}, where V_{eff}=Vₚₑₐₖ/\sqrt{2}. This results in a large power burn in the cable which is undesirable.

DC powering is thus often used to reduce this power burned in the cables with the voltage supplied to the active elements kept fairly constant and maintained above the value of the effective voltage. However issues then arise with galvanic corrosion and to address this the polarity of the DC power supply has to change periodically.

Switching the polarity of the DC power supply is straightforward but in an HFC network switching can cause active elements to switch off inadvertently disrupting the network and also can also cause issues with signal quality.

### SUMMARY OF THE INVENTION

In accordance with one aspect of the present invention, there is provided a hybrid fiber coaxial network polarity switching module connectable to a DC power signal obtained from an AC power signal and comprising a controller in electrical communication with an H-bridge circuit, wherein the controller is configured to act on the H-bridge circuit to switch polarity of the DC power signal during a transition time less than or equal to the effective time of the AC power signal, thereby to ensure the polarity change avoids powering down of active components. The effective time is defined as the time interval during which the positive voltage of the AC power signal is greater than the effective or RMS voltage Vₚₑₐₖ/\sqrt{2}. Switching polarity from positive to negative DC power signal and vice versa is undertaken as necessary to address galvanic corrosion within the network.

Preferably the DC power signal is obtained from full wave rectification and smoothing of the AC power signal.

The module preferably switches polarity between a positive effective voltage and a negative effective voltage occurring within one half cycle of the alternating waveform, these being spaced apart by the effective time and representing adjacent values of the positive effective voltage and the negative effective voltage within one cycle of the alternating waveform. Typically a first switch in polarity will take place between a positive effective voltage and a negative effective voltage occurring within one half cycle of the alternating waveform to change from a positive DC power signal to a negative DC power signal and then at a later time when switching is required again due to galvanic corrosion considerations, a second switch will take place between a negative effective voltage and a positive effective voltage occurring within one half cycle of the alternating waveform so as to switch from a negative DC power signal to a positive DC power signal. Polarity switching from a positive to a negative DC power signal and vice versa is typically repeatedly undertaken as necessary to address galvanic corrosion within the network.

The alternating waveform may be trapezoidal or sinusoidal but is of preference sinusoidal.

The transition time preferably equals the effective time of the AC power signal.

For a sinusoidal 50 Hz AC power signal, the transition time is 5 ms or less, 5 ms matching the effective time of a 50 Hz signal.

There is also provided a hybrid fiber coaxial network incorporating a polarity switching module as discussed above.

In accordance with another aspect of the invention, there is provided a method of switching polarity in an HFC network comprising taking a DC power signal obtained from an AC power signal, passing the DC power signal through an H-bridge circuit and controlling the H-bridge circuit to switch polarity of the DC power signal within a transition time less than or equal to the effective time of the AC power signal. The effective time is defined as the time interval during which the positive voltage of the AC power signal is greater than the effective or RMS voltage Vₚₑₐₖ/\sqrt{2}.

Preferably the DC power signal is obtained from full wave rectification and smoothing of the AC power signal.

The H-bridge circuit is preferably controlled to switch polarity between a positive effective voltage and a negative effective voltage occurring within one half cycle of the alternating waveform.

The transition time may equal the effective time of the AC power signal.

For a sinusoidal 50 Hz AC supply, preferably the transition time is 5 ms or less.

The invention will now be described by way of example and with reference to the accompanying drawings in which:

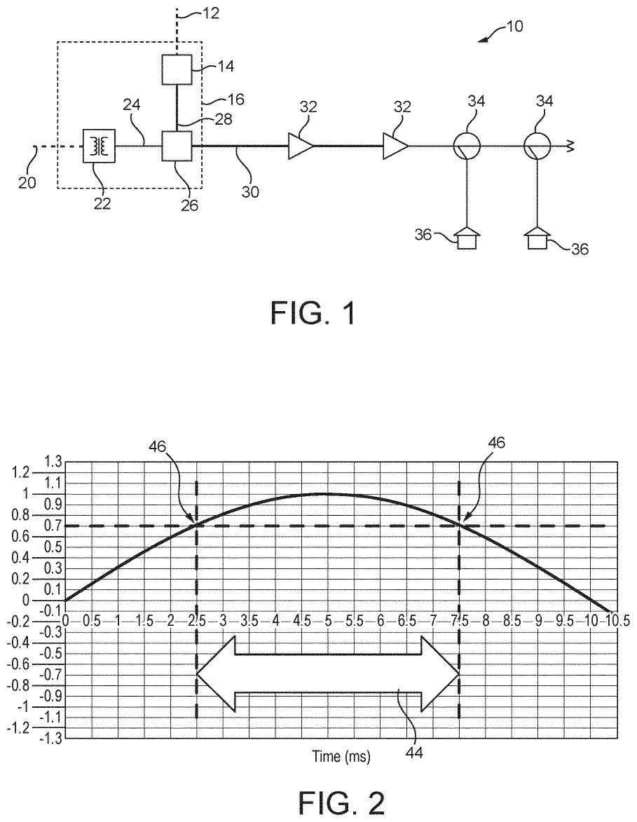

FIG. 1 is a schematic diagram of an HFC network;

FIG. 2 is an explanatory graph in relation to an AC power signal;

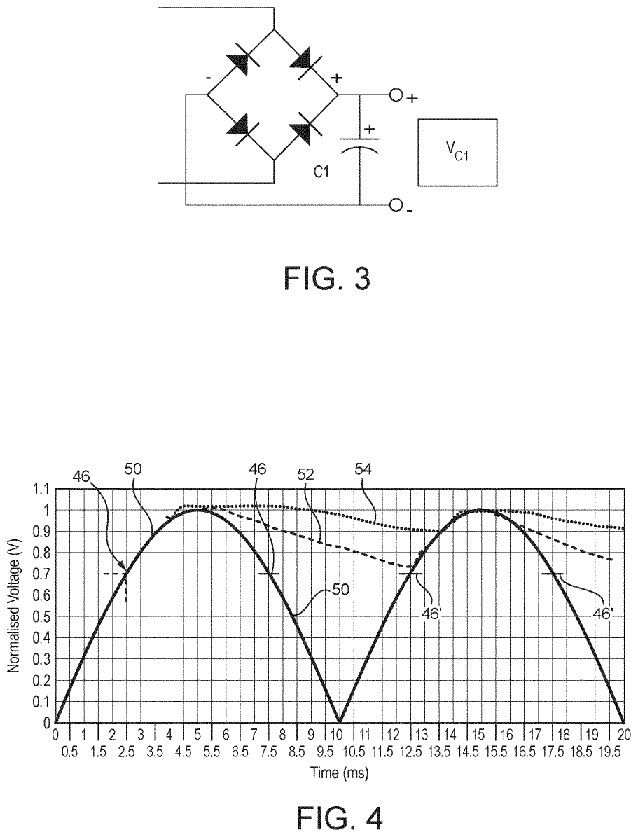

FIG. 3 is an example of a circuit used for rectification and smoothing of an AC power signal;

FIG. 4 is an explanatory graph illustrating a rectified DC power signal;

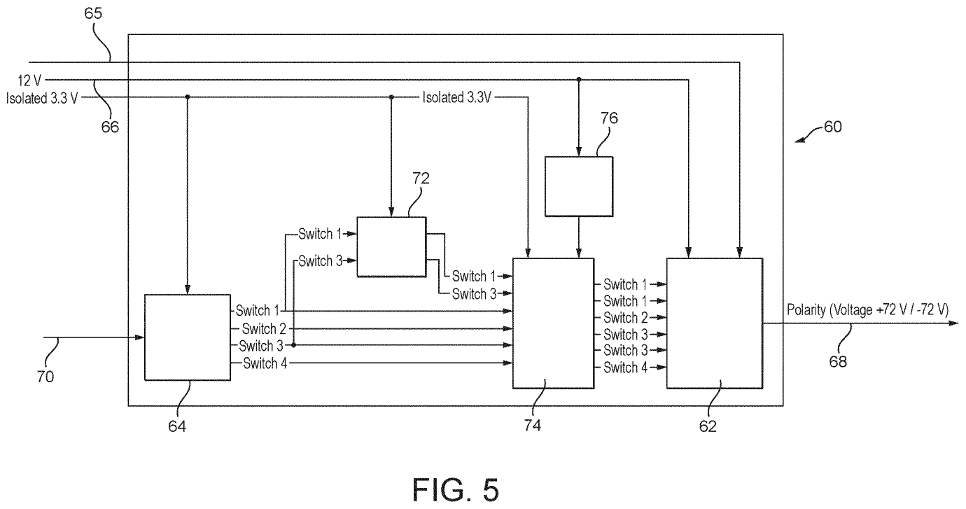

FIG. 5 is a schematic diagram of a polarity switching module in accordance with the invention;

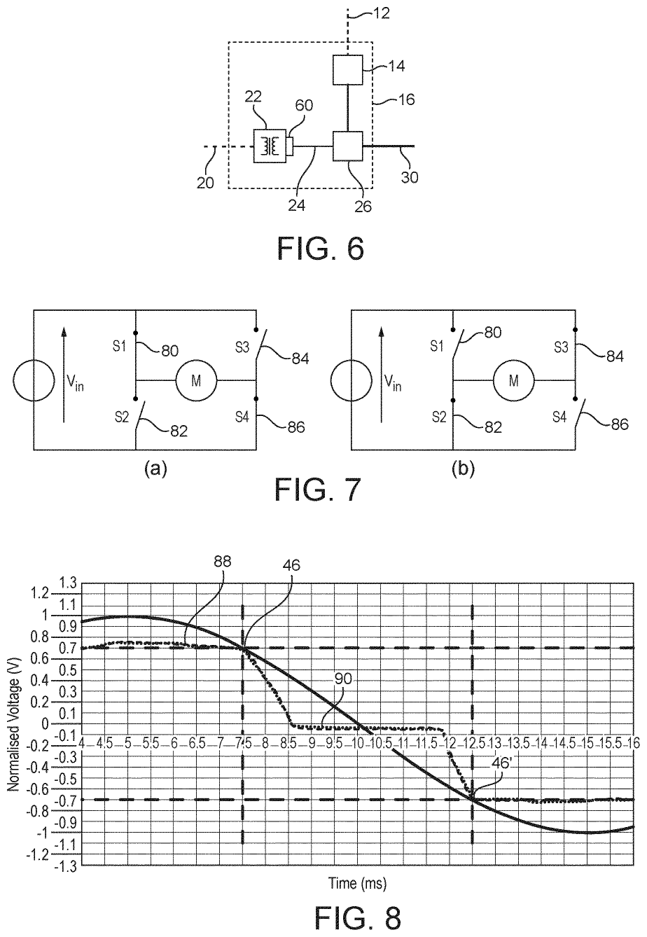

FIG. 6 is a schematic diagram showing placement of the module within the HFC network;

FIGS. 7(a) and 7(b) are diagrams explaining operation of an H-bridge circuit; and

FIG. 8 is an explanatory graph illustrating polarity switching when using the module of FIG. 5.

### DESCRIPTION

Part of a typical HFC communication/broadband network 10 is shown in FIG. 1 where signal from a headend (not shown) is fed along optical fiber 12 to reach optical node 14 situated within a fiber to coax cabinet 16. A mains AC power supply 20 connects to an internal power supply 22 with transformer to generate a lower voltage signal which travels along coaxial cable 24 to reach power inserter 26. A converted RF signal from optical node 14 is also fed to power inserter 26 by way of coaxial cable 28. The combined signal from power inserter 26 travels along coaxial cable 30 to reach a plurality of amplifiers 32, with at least some of these amplifiers associated with taps 34 and other network elements to supply a plurality of end users 36. Bi-directional broadband and/or communication signals travel between the headend and users.

Typically the mains AC power signal is a 50 Hz sinusoidal signal, as shown in FIG. 2. The effective time 44 is defined as the time over which the voltage of the sinusoid is greater than the positive effective voltage V_{eff} 46 where V_{eff}=Vₚₑₐₖ/\sqrt{2} and for a 50 Hz supply the effective time is 5 ms. The effective voltage is also known as the RMS voltage.

DC powering is preferred for the active elements such as nodes and amplifiers within HFC network 10 and so a rectifier consisting of four diodes is combined with at least one capacitor, see FIG. 3, to convert the AC power signal into a DC power signal using full-wave rectification with smoothing. The rectifier and capacitor arrangement is used in combination with power supply 22 within an HFC network to supply a DC power signal along coaxial cable 24. FIG. 4 shows the voltage behavior 50 of the rectifier where the negative half-cycle of the AC power signal is inverted and also shows the smoothed DC voltage 52, 54 for different capacitor values.

To mitigate galvanic corrosion, the polarity of the DC voltage needs to be changed periodically, such as daily, weekly, or per hour, but if switching from a positive to negative voltage, and vice versa, is too quick it can cause harmonic products that mix with the signal transported in the network and affect signal quality. A bigger problem is that if the switching is too slow, the active elements power off and these elements can take some time to become active again, for example, a Remote Phy (RPHY) or Remote MACPhy (RMACPhy) device takes 15 minutes to reboot causing a serious disruption in the network.

A polarity switching module 60 in accordance with the invention is shown schematically in FIG. 5 comprising an H-bridge circuit 62 and associated controller 64. Typically such a module is an output stage module connected between power supply 22 and coaxial cable 24, see FIG. 6. Module 60 comprises a first input 65 receiving the smoothed rectified DC power signal obtained from power supply 22 and a second input 66 being a 12V line connected to H-bridge circuit 62 which generates an output DC voltage 68 of positive or negative polarity. The polarity state is controlled by a switch input 70 associated with controller 64 which acts on inverter 72 and signal isolator 74 to switch H-bridge circuit 62, and thus switch polarity of the input DC power signal. A 5V linear and low drop out regulator 76 is connected between input power line 66 and signal isolator 74 so as to provide the appropriate voltage to isolator 74.

H-bridge circuit 62 relies on a combination of four switches to switch polarity, see FIGS. 7(a) and (b). In FIG. 7(a) switches 80 and 86 are closed and switches 82 and 84 are open. In this configuration the voltage in the load is positive. In FIG. 7(b) switches 80 and 86 are open and switches 82 and 84 are closed. In this configuration the voltage in the load is negative.

Controller 64 is able to control how fast switches 80, 82, 84 and 86 open and close and to ensure that no short circuits take place within H-bridge circuit 62. Controller 64 is configured to ensure H-bridge circuit 62 switches polarity in a transition time less than or equal to the effective time and desirably during the time between the positive V_{eff} 46 to the negative V_{eff} 46′, see FIG. 8, following trace 88. The time between the positive V_{eff} 46 to the negative V_{eff} 46′ is also the same as the effective time discussed in relation to FIG. 2. More rapid switching by controller 64 will reduce the extent of plateau 90 and so achieve switching for a transition time less than the effective time. For a 50 Hz AC supply the transition time is less than or equal to 5 ms, 5 ms being the effective time for a 50 Hz sinusoidal supply. FIG. 8 shows a switch in polarity from a positive DC power signal to a negative DC power signal. A reverse switch from a negative DC power signal to a positive DC power signal will take place when the next switch in polarity is required due to galvanic corrosion considerations.

In FIG. 8 the original AC power signal is shown before rectification so that the timing of the polarity switch, which takes place on the rectified smoothed signal, can be understood. The equivalent positions of positive V_{eff} 46 and negative V_{eff} 46′ for the rectified and smoothed DC power signal are indicated on FIG. 4. By ensuring switching takes place during a transition time no greater than the effective time, the switch from one polarity to the other is rapid enough to ensure that no active elements switch off due to a slow transition. If desired, controller 64 is configured to produce a switching transition time precisely matching the effective time between the positive V_{eff} 46 to the negative V_{eff} 46′, and thus for a 50 Hz AC switch within a transition time of 5 ms, and so ensure substantially no harmonics are generated. The transition can be selected to be faster than 5 ms if desired with low pass filters within the power supplies of the active elements then used to filter out any harmonics.

The switch in polarity thus takes place during the transition of sinusoid signal of 50 Hz from the positive effective voltage to the negative effective voltage, and vice versa, over a transition time less than or equal to the effective time. By doing this, all the active elements in the HFC network remain live during the switch in the polarity and do not switch off, avoiding network interruptions.

1. A hybrid fiber coaxial network polarity switching module connectable to a DC power signal obtained from an AC power signal and comprising a controller in electrical communication with an H-bridge circuit, wherein the controller is configured to act on the H-bridge circuit to switch polarity of the DC power signal during a transition time less than or equal to the effective time of the AC power signal.

2. A hybrid fiber coaxial network polarity switching module according to claim 1, wherein the DC power signal is obtained from full wave rectification and smoothing of the AC power signal.

3. A hybrid fiber coaxial network polarity switching module according to claim 1, wherein the switch in polarity takes place between a positive effective voltage and a negative effective voltage occurring within one half cycle of the alternating waveform.

4. A hybrid fiber coaxial network polarity switching module according to claim 1, wherein the alternating waveform is sinusoidal.

5. A hybrid fiber coaxial network polarity switching module according to claim 1, wherein the transition time is equal to the effective time of the AC power signal.

6. A hybrid fiber coaxial network polarity switching module according to claim 1, wherein the AC power signal is a sinusoidal 50 Hz signal and the transition time is 5 ms or less.

7. A hybrid fiber coaxial network incorporating a polarity switching module in accordance with claim 1.

8. A method of switching polarity in an HFC network comprising passing a DC power signal obtained from an AC power signal through an H-bridge circuit and controlling the H-bridge circuit to switch polarity of the DC power signal during transition time less than or equal to the effective time of the AC power signal.

9. A method of switching polarity in an HFC network according to claim 8, wherein the H-bridge circuit is controlled to switch polarity between a positive effective voltage and a negative effective voltage occurring within one half cycle of the alternating waveform.

10. A method of switching polarity in an HFC network according to claim 8, wherein the DC power signal is obtained from full wave rectification and smoothing of the AC power signal.

11. A method of switching polarity in an HFC network according to claim 8, wherein the transition time matches the effective time of the AC power signal.

12. A method of switching polarity in an HFC network according to claim 8, wherein the AC power signal is a sinusoidal 50 Hz signal and the transition time is 5 ms or less.
